(19) United States
(12) Patent Application Publication
(10) Pub. No.: US 2013/0119810 A1
(43) Pub. Date: May 16, 2013

(54) ELECTRIC ROTATING MACHINE

(71) Applicant: SUZUKI MOTOR CORPORATION, Shizuoka (JP)

(72) Inventor: Masahiro AOYAMA, Shizuoka (JP)

(73) Assignee: SUZUKI MOTOR CORPORATION, Shizuoka (JP)

(21) Appl. No.: 13/658,849

(22) Filed: Oct. 24, 2012

(30) Foreign Application Priority Data
Nov. 16, 2011 (JP) 2011-250879

(51) Int. Cl. H02K 1/16

(52) U.S. Cl. 310/156.53

(57) ABSTRACT

The present invention provides an electric rotating machine capable of providing a high quality and efficient machine operation with reduced oscillation and noise by lowering torque ripple. The electric rotating machine includes a stator having a plurality of teeth facing a rotor, and a plurality of slots providing spaces for winding coils around the teeth. The rotor has a pair of permanent magnets embedded therein and located in a “V” shape configuration. Six slots of each set of the plurality of slots face one magnetic pole formed by the permanent magnets of each pair and the adjacent flux barriers. The plurality of teeth includes long teeth and short teeth. The distance xL between each of the long teeth and the rotor and the distance xS between each of the short teeth and the rotor meet the condition 0.1≦(xS−xL)/xL≦0.3.

### RELATED APPLICATION

The present application claims priority to Japanese Patent Application No. 2011-250879 filed on Nov. 16, 2011, the entire content of which is being incorporated herein by reference.

### TECHNICAL FIELD

The present invention relates to an electric rotating machine and more particularly to a permanent magnet electric machine capable of acting as an electric motor providing high quality drive.

### BACKGROUND ART

Electric rotating machines are required to have varying characteristics with different types of equipment in which they are used. For example, it is required that an electrical machine acts as a variable speed motor over a wide range as well as a high torque motor for low revolution speed operation when it is used, as a traction motor, in a hybrid electric vehicle (HEV) with an internal combustion engine or an electric vehicle (EV) as a driving source.

It is proposed for an electric machine with such characteristics to construct by adopting an interior permanent magnet (IPM) structure in which a plurality of pairs of permanent magnets are embedded in a rotor in a way that the magnets of each pair are located in a “V” shape configuration opening toward the rotor periphery because it is advantageous to use a structure that can effectively utilize reluctance torque together with magnetic torque, see e.g. patent literature 1.

In an electric rotating machine with such IPM structure, a plurality of pairs of permanent magnets are embedded in a rotor in a way that the permanent magnets of each pair are located in a “V” shape configuration to keep q-axis magnetic paths in order to effectively utilize reluctance torque. This increases the proportion of reluctance torque to magnetic torque and also saliency ratio (Ld/Lq), a ratio between inductance in d-axis and inductance in q-axis, resulting in increased tendency of space harmonics of the higher order to overlap flux waveform. The d-axis is aligned with a direction of flux generated by magnetic poles and acts as a center axis between each pair of permanent magnets located in “V” shape, while the q-axis is at an angle of 90 in electrical degrees from the d-axis electrically and magnetically and acts as a center axis between the adjacent magnetic poles (i.e., the adjacent pairs of permanent magnets).

This causes high torque ripple, i.e., the difference between maximum and minimum torque during one revolution, in such electric rotating machine. The high torque ripple causes an increase in oscillation of the machine and electromagnetic noise. Especially, electromagnetic noise is desired to be reduced as much as possible because it gives an unpleasant sound to occupant(s) in a vehicle having, as an electric drive, the electric machine due to a relatively high frequency of the electromagnetic noise to that of noise generated by drive of an internal combustion engine.

On the other hand, highly efficient drive by the electric rotating machine is demanded to generate a desired driving force efficiently with less consumption of electricity but oscillation becomes loss to cause a reduction in the efficiency.

Following not only restrictions of loading space, but also recent demands of improvement in energy conversion efficiency (mileage) in hybrid and electric cars, there is a growing demand of lightweight and miniaturization in electric rotating machines capable of providing high energy density output. Reducing torque ripple is effective to control judder, abnormal vibrations, and to provide smooth acceleration performance because, for example, there is a need to provide highly efficient drive over a usually used range for driving a car in street use.

It is very difficult to combine miniaturization as stand-alone units with improved efficiency, reduced electromagnetic noise and low torque ripple because, in electric rotating machines (motors), there are a tendency of increase in electromagnetic noise and a tendency of decrease in efficiency caused due to occurrence of torque ripple in accordance with an increase in output density per unit volume, but the demand of lightweight and miniaturization is growing.

In order to realize low electromagnetic noise and low torque ripple, it is proposed to axially divide a rotor to allow one of the adjacent pairs of permanent magnets to assume an angularly twisted positional relation with the other or give a skew angle (see, for example, patent literature 2).

The above-mentioned measure to give a skew angle in an electric rotating machine causes not only an increase in assembly cost and thus an increase in production cost, but also a difference at interfaces of the adjacent pairs of permanent magnets and a deterioration of the rate of magnetization at the interfaces, causing the permanent magnets to lower their magnetic flux density. As a result, the output torque to be produced by the electric rotating machine drops.

This is why various different ideas from the measure to give a skew angle are proposed to realize low electromagnetic noise and low torque ripple. They include an approach to modify an air gap between a rotor and a stator surrounding the rotor in such a way that an air gap distance at a position where every p-axis intersects the air gap is greater than air gap distances at the other positions by, for example, modifying the shape of the rotor periphery in such a way that the rotor periphery has a bulged shape at every magnetic pole like a “petal” shape (see, for example, patent literatures 1, 3 and 4).

In electric rotating machines described in patent literatures 1, 3 and 4, an inductance at every p-axis, which serves as a magnetic axis of one of magnetic poles created by permanent magnets on a rotor, increases because an air gap is wide, causing not only a drop in saliency ratio and a drop in torque, but also a decrease in machine efficiency.

### PRIOR ART DOCUMENT

### Patent Literature

Patent Literature 1: JP patent application laid-open publication No. 2008-99418 (P2008-99418A)
Patent Literature 2: JP patent application laid-open publication No. 2006-304546 (P2006-304546A)
Patent Literature 3: JP patent application laid-open publication No. 2000-197292 (P2000-197292A)
Patent Literature 4: JP patent application laid-open publication No. 2007-312591 (P2007-312591A)

### SUMMARY OF THE INVENTION

Thus, an object of the present invention is to provide an electric rotating machine capable of providing a high quality and efficient machine operation with reduced oscillation and noise by preventing any drop in torque output and lowering torque ripple.

According to a first aspect of the present invention, there is provided an electric rotating machine comprising a rotor with a rotor shaft located on a rotor axis and a stator rotatably receiving the rotor,

wherein said stator includes a plurality of teeth, which extend towards an outer periphery surface of said rotor and terminate at inner peripheral surfaces facing the peripheral surface of said rotor, and a plurality of slots, each between the adjacent two of the teeth, providing spaces for winding coils around said teeth for input of driving electric power,

wherein said rotor has a plurality of permanent magnets embedded therein so as to let magnetic force act on that surface portions of the teeth which are opposed to the permanent magnets,

wherein said rotor within said stator is driven to revolve by reluctance torque derived from magnetic flux passing through said teeth, rear surface side of the teeth and said rotor when current passes through said coils and magnet torque in the form of attraction and repulsion derived from interference with said permanent magnets,

wherein, when a set of permanent magnets of said plurality of permanent magnets corresponds to a set of slots of said plurality of slots and forms a magnet pole, magnetic reluctance between an inner periphery surface per tooth of said plurality of teeth and the outer periphery surface of said rotor is modified in such a way as to adjust torque fluctuation per tooth of said plurality of teeth upon relative movement of said one magnetic pole to said set of slots.

According to a second aspect of the present invention, in addition to the specified matter by the first aspect, said plurality of teeth includes two kinds in length of teeth such that every other tooth of said plurality of teeth is of the one of the two kinds and an adjacent tooth is of the other of the two kinds.

According to a third aspect of the present invention, in addition to the specified matter by the second aspect, said one magnetic pole in said rotor is formed by embedding said one set of permanent magnets so that permanent magnets of a pair are located in a “V” shape configuration opening towards the outer periphery surface of said rotor, slots of said one set of said stator are six in number, and said plurality of teeth include long first teeth and short second teeth, each of said first long teeth and each of said second short teeth meeting the following condition:

0.1≦d/D1≦0.3

where D1 is the air gap distance between an inner periphery surface of each of the first long teeth and the outer periphery surface of said rotor, D2 is the air gap distance between an inner periphery surface of each of the second short teeth and the outer periphery surface of said rotor, and d is the difference between the distances D2 and D1 (D2−D1).

According to the first aspect of the present invention, torque fluctuation upon relative movement of one magnetic pole to the stator, which is caused by magnetic flux created during excitation of coils on the stator passing from the stator teeth to the rotor, is adjusted by modifying magnetic reluctance per tooth facing the one magnetic pole. This makes it easy to adjust the torque fluctuation that is created by passing of the magnetic flux per tooth to the rotor. For example, torque ripple can be lowered by gradually changing the torque. As a result, there are provided a high quality and efficient machine operation with reduced oscillation and noise and at the same time with reduced losses.

According to the preceding second aspect, two kinds in length of stator teeth are arranged such that every other tooth is shorter than an adjacent tooth. As a result, a high quality machine operation with reduced oscillation and noise is provided and at the same time a highly efficient machine operation with reduced losses is provided because torque ripple and the like are effectively lowered or tamed.

According to the preceding third aspect, in the case one magnetic pole of permanent magnets of each pair corresponds to a set of six slots, each of first long stator teeth and each of second short stator teeth meet the condition 0.1≦d/D1≦0.3, where D1 is the distance from each of the first long stator teeth to the rotor, D2 is the distance from each of the second short stator teeth to the rotor, and d is the difference between the distances D2 and D1 (D2−D1). This also results in providing a high quality machine operation with reduced oscillation and noise and at the same time a highly efficient machine operation with reduced losses because torque ripple and the like are effectively lowered or tamed.

### BRIEF DESCRIPTION OF THE DRAWINGS

FIG. 1 is a plan view showing one implementation of an electric rotating machine according to the present invention, showing the outline of its overall structure.

FIG. 2 is a plan view showing magnetic flux flow pattern produced by a stator of the machine when a rotor of the machine has no magnetic poles.

FIG. 3 is a graphical representation of a magnetic flux waveform illustrating a solution to accomplish the object of the present invention.

FIG. 4 is a graphical representation of a torque waveform illustrating the solution to accomplish the object of the present invention.

FIG. 5 is a plan view showing structural requirements of the implementation.

FIG. 6 is a fragmentary enlarged plan view of a model for the structural requirements of the implementation.

FIG. 7 is a graphical representation used to determine the structural requirements.

FIG. 8 is a graphical representation used to verify the effects of the structural requirements.

FIG. 9 is a different graphical representation from FIG. 8 used to verify the effects of the structural requirements.

FIG. 10 is a different graphical representation from FIGS. 8 and 9 used to verify the effects of the structural requirements.

### DESCRIPTION OF IMPLEMENTATION

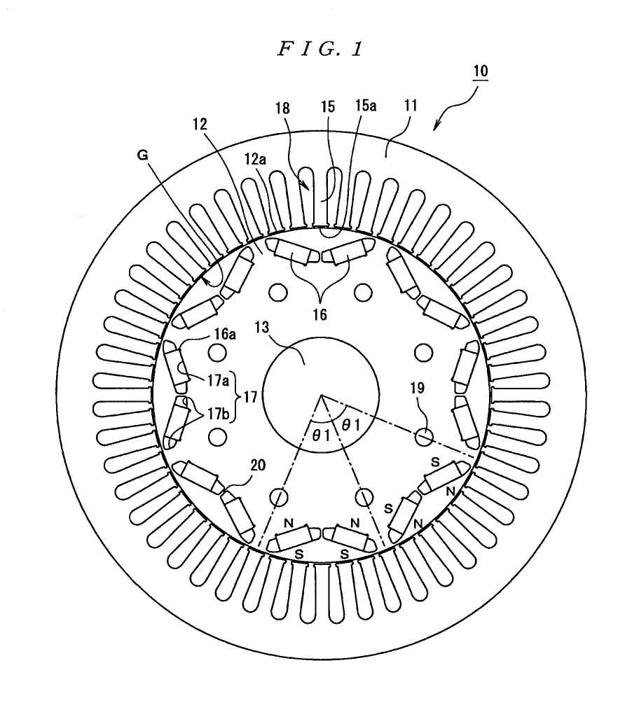

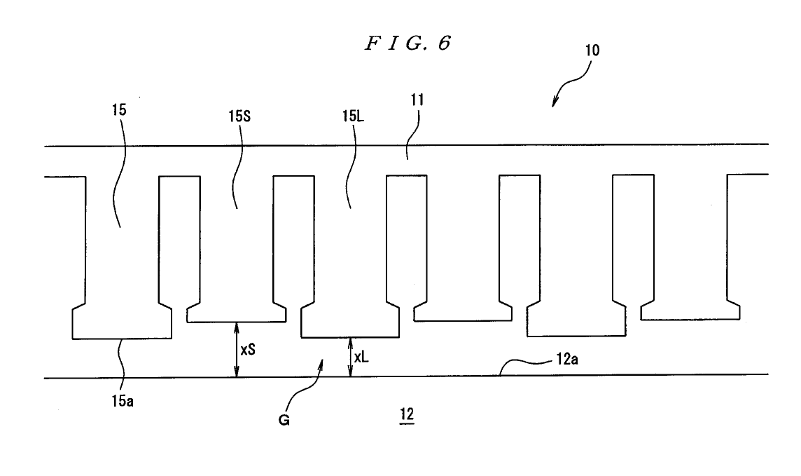

Referring to the accompanying drawings, implementation of the present invention is specifically explained below. FIGS. 1 through 10 show one implementation of an electric rotating machine according to the present invention.

Referring to FIG. 1, an electric rotating machine (motor) 10 has a good performance for use in, for example, a hybrid electric car or electric car as a driving source in a manner similar to an internal combustion engine or as an in-wheel drive unit, and it includes a stator 11 formed in a cylindrical configuration and a rotor 12 rotatably received in the stator 11 with a rotor shaft 13 in a way that the rotor 12 is located on a rotor axis that is common to an axis for the stator 11.

With an air gap G between the stator 11 and the rotor 12, the stator 11 includes slots 18 extending toward the rotor axis throughout an inner circular margin, and a plurality of stator teeth 15 defined by the slots 18. The stator teeth 15 extend in radial directions toward the rotor axis with their ends facing an outer circular periphery surface 12a of the rotor 12 with the air gap G between them. The stator teeth 15 are wound to provide a three-phase distributed winding (not shown) to form coil windings configured to induce flux patterns for creation of rotor torque imparted to the rotor 12.

The rotor 12 is an interior permanent magnet (IPM) rotor which has embedded therein a plurality of sets (pairs in this example) of permanent magnets 16 in a way that magnets of each set include a pair of permanent magnets 16 located in a “V” shape configuration opening toward its outer circular periphery surface 12a. The rotor 12 is formed with a plurality of pairs of bores 17 which are located in a “V” shape configuration opening toward the outer circular periphery surface 12a and extend axially through the rotor 12. The bores 17 of each pair include a pair of bore sections 17a in which the permanent magnets 16 of each pair, which are tabular magnets, are accommodated and kept immobile with their corner portions 16a each inserted into and held in a face-to-face relationship to the adjacent two angled inner walls defining the corresponding bore section 17a. Each of the bores 17 includes two space sections 17h that are located on the opposite sides of the corresponding tabular magnet 16 and spaced in a width direction of the magnet 16 to function as flux barriers for restricting sneak flux (called hereinafter “flux barriers”). The bores 17 of each pair are provided with a center bridge 20 interconnecting the permanent magnets 16 of the associated pair in order to retain the permanent magnets 16 in appropriate position against the centrifugal force at high speed revolutions of the rotor 12.

In this electric rotating machine 10, the stator teeth 15 are angularly distant to provide spaces, as the slots 18, to accommodate coil windings, so that six stator teeth 15 cooperate with the corresponding one of eight sets of permanent magnets 16, in other words, six (6) slots 18 face one of eight sets of permanent magnets 16. For this reason, the electric rotating machine 10 is configured to act as an 8-pole 48-slot three-phase IPM motor including eight (8) magnetic poles (four pairs of magnetic poles) for eight (8) sets of permanent magnets 16, in which N-poles and S-poles of the permanent magnets 16 of each set are rotated 180 in mechanical degrees with respect to those of the adjacent set, and forty eight (48) slots 18 accommodating coil windings formed by a single phase distributed winding using six (6) slots 18 defining five (5) stator teeth 15. The illustrated labeling N and S are used for the convenience sake in this explanation, but they are not on the surfaces of the components.

This structure causes the electric rotating machine 10 to drive the rotor 12 and the rotor shaft 13 when the coil windings in the slots 18 are excited so that magnetic flux flow patterns pass from the stator teeth 15 into the rotor 12 inwardly from the outer circular periphery surface 12a because rotor torque is created by, in addition to magnet torque derived from attraction and repulsion by interaction of the magnetic flux flow patterns with flux flow patterns for the magnetic poles for the permanent magnets 16 of each set, reluctance torque tending to minimize magnetic flow paths for the magnetic flux flow patterns from the stator 11.

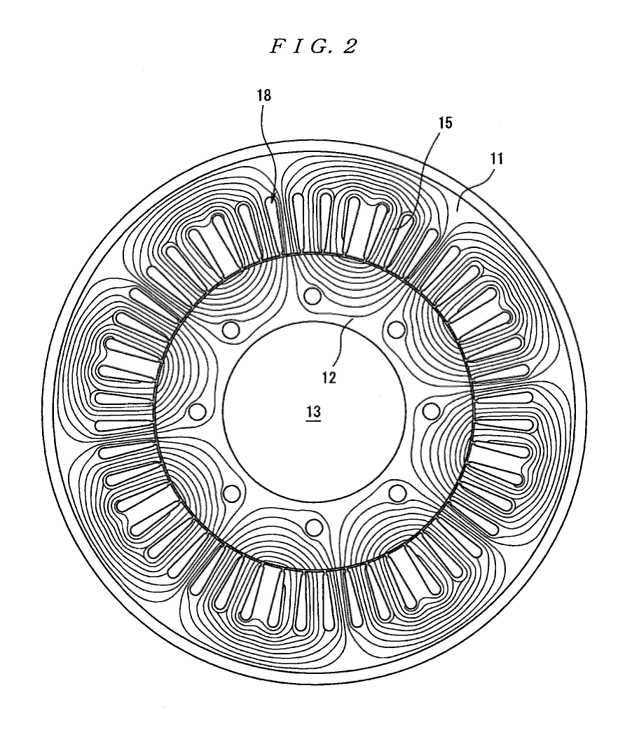

As shown in FIG. 2, the electric rotating machine 10 has the coil windings accommodated in the slots 18 formed by the distributed winding so as to provide a flux flow pattern, which includes distributed magnetic paths, from the stator 11 into the rotor 12 for each of a plurality sets of stator teeth 15 corresponding to one of the magnetic poles for the plurality pairs of permanent magnets 16. The V shape bores 17 of each pair for the permanent magnets 16 extend along the magnetic paths or, in other words, in a manner not to disturb formation of such magnetic paths. It is noted that laminations of magnetic steel such as, silicon steel or the like, are arranged in stacked axial relation to an appropriate thickness for a desired output torque and fastened by fastening screws using tappet holes 19 in a manufacturing process of the stator 11 and the rotor 12.

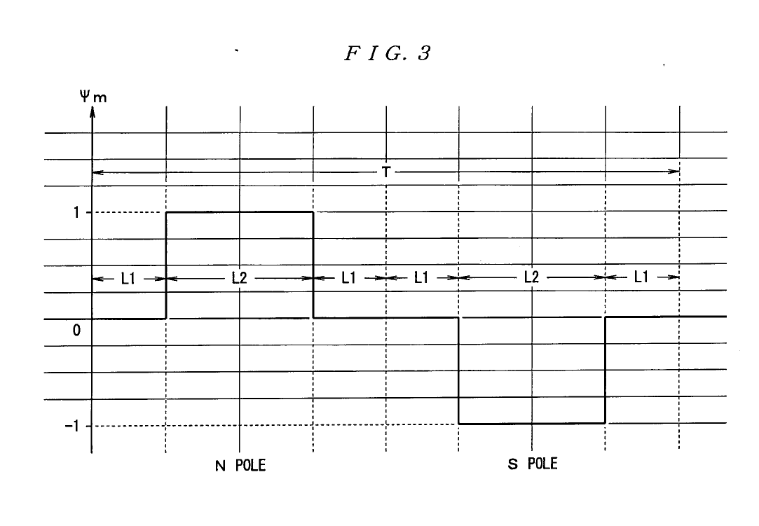

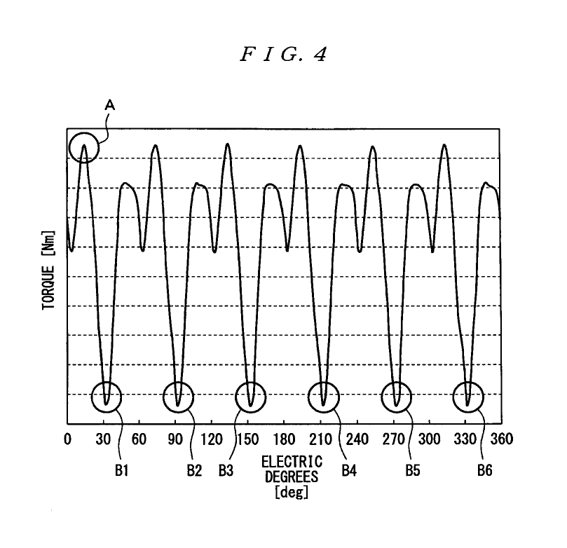

Considering now the electric rotating machine 10 employing the IPM structure in which the permanent magnets 16 are embedded in the rotor 12, the variation of the magnetic flux in one tooth of the stator teeth 15 of the stator 11 may be approximated by a square waveform shown in FIG. 3. Superposition of this fundamental magnetic flux wave and space harmonics of the lower order, the fifth (5^{th}) and the seventh (7^{th}) harmonic, are a factor that affects not only oscillation and noise experienced by the vehicle occupants, but also iron losses and a decrease in machine operating efficiency derived from a loss as thermal energy created by high torque ripple, (i.e., the difference between maximum and minimum torque during one revolution). Suppressing the space harmonics reduces the iron losses to improve machine operating efficiency with respect to input of electrical energy because hysteresis loss is the product of frequency and magnetic flux density and eddy current loss is the product of the square of frequency and magnetic flux density. Turning to FIG. 4, with the vertical axis representing magnetic flux and the horizontal axis representing time, the illustrated square waveform approximates the variation of the magnetic flux in one tooth of the stator teeth 15 over one cycle T (4L1+2L2) in electrical degrees in which no magnetic flux passes through the tooth for a duration L1 and magnetic flux with an amplitude passes forwardly through the tooth for a duration L2 of the first half of the cycle T and reversely through the tooth for the duration L2 of the second half of the cycle T.

Electromagnetic noise from the motor (electric rotating machine) is generated by oscillation of the stator caused by electromagnetic force acting on the stator. As the electromagnetic force acting on the stator, there exist radial electromagnetic force derived from magnetic coupling between the rotor and the stator and angular electromagnetic force derived from torque. Considering radial electromagnetic force acting on each of the stator teeth 15 with a linear magnetic circuit approximating the motor, the radial electromagnetic force fr and magnetic energy W can be expressed in the following formulae (1) and (2) as

$$\begin{matrix}W = \frac{1}{2} {φ}^{2} {R}_{g} = \frac{1}{2} {( B \cdot S )}^{2} \cdot \frac{x}{μ S} = \frac{1}{2 μ} {B}^{2} \cdot x \cdot S & ( 1 ) \\ fr = \frac{\partial W}{\partial x} = \frac{1}{2 μ} {B}^{2} S \frac{\partial }{\partial x} ( x ) = \frac{1}{2 μ} {B}^{2} S & ( 2 )\end{matrix}$$

where φ is the magnetic flux, W is the magnetic energy, fr is the radial electromagnetic force, Rg is the reluctance, B is the magnetic flux density, S is an area through which the magnetic flux passes, x is the air gap (G) distance, and ε is the permeability in magnetic path.

Taking space harmonics into account, the flux density B can be expressed as shown in the following formula (3), so it follows that the superposition of the fundamental and the space harmonics is a factor that increases the radial electromagnetic force fr because the radial electromagnetic force fr includes the square of the flux density B. Diligent examination and study by the inventor has proven that reducing the space harmonics lowers torque ripple, resulting in realization of not only a reduction in motor electromagnetic noise, but also an improved machine operating efficiency.

$$B = {\sum }_{t = 1}^{t} Bt sin t ( θ + δ t ) \qquad ( 3 )$$

Inventor's diligent examination and study have also proven that torque ripple in an IPM three-phase motor results from the 6f^{th} (where f=1, 2, 3, . . . : the natural number) harmonic components at θ in electrical degrees, which result from combining, with respect to one phase for one magnetic pole, space harmonics with time harmonics contained in the input phase current supply.

More precisely, three-phase output P(t) and torque τ(t) can be given by the expressions in the following formulae (4) and (5)

P(t)=Eᵤ(t)Iᵤ(t)Eᵥ(t)Iᵥ(t)+E_{w}(t)I_{w}(t)=ωₘ·τ(t) (4)

τ(t)=[Eᵤ(t)Iᵤ(t)+Eᵥ(t)+Iᵥ(t)+E_{w}(t)I_{w}(t)]/ωₘ (5)

where ωₘ is the angular velocity; Eᵤ(t), E(t) and E_{w}(t) are the U phase, V phase and W phase induced voltages, respectively; and Iᵤ(t), Iᵥ(t) and I_{w}(t) are the U phase, V phase and W phase currents, respectively.

Three phase torque is the sum of the U phase, V phase and W phase torques. Assuming that m is the order of harmonic component in the current and n is the order of harmonic component in the voltage, the U phase induced voltage Eᵤ(t) can be written as in the following formula (6) and the U phase current Iᵤ (t) can be written as in the following formula (7), and the U phase torque τᵤ(t) can be given by the expression shown in the following formula (8).

$$\begin{matrix} {E}_{u} ( t ) = {\sum }_{n = 1}^{n} {E}_{n} sin n \cdot ( θ + {α}_{n} ) & ( 6 ) \\ {I}_{u} ( t ) = {\sum }_{m = 1}^{m} {I}_{m} sin m \cdot ( θ + {β}_{m} ) & ( 7 ) \\ {τ}_{u} ( t ) = \frac{1}{ω m} [ {\sum }_{n = 1}^{n} {\sum }_{m = 1}^{m} {E}_{m} {I}_{m} \{ - \frac{1}{2} ( cos ( ( n + m ) θ + n {α}_{n} + m {β}_{m} ) - cos ( ( n - m ) θ + n {α}_{n} - m {β}_{m} ) \} ] & ( 8 )\end{matrix}$$

It is well known that phase voltage E(t) and phase current I(t) are symmetrical waves, so n and m are odd numbers only It is further known that the V phase induced voltage Eᵥ(t) and current Iᵥ(t) for the V phase torque and the W phase induced voltage E_{w}(t) and current I_{w}(t) for the W phase torque are +2π/3 radians and −2π/3 radians shifted from the U phase induced voltage Eᵤ(t) and current Iᵤ(t) for the U phase torque, respectively. It is seen that, in the expression of the three-phase torque, terms with coefficient 6 only remain and all of the other terms are cancelled each other. It follows that the three-phase torque τ(t) can be written as in the following formula (9)

$$τ ( t ) = \frac{1}{ω m} [ {\sum }_{n = 1}^{n} {\sum }_{m = 1}^{m} {E}_{m} {I}_{m} \{ - \frac{1}{2} \{ 3 cos ( 6 f θ + s ) - 3 cos ( 6 f θ + t ) \} \} ] \qquad ( 9 )$$

where 6f=n±m (f is the natural number), s=nαₙ±mβₘ, t=nαₙ−mβ.

It has become clear from the above formula that when the order n of space harmonics contained in the flux (induced voltage) and the order m of time harmonics contained in the phase supply current are combined to give the number 6f, torque ripples of the 6f^{th} order are generated in the three-phase AC motor because, as an induced voltage is known as the time derivative of a magnetic flux, the harmonics contained in the induction voltage for each phase are of the same order as the harmonics contained in one phase one magnetic pole flux of the same phase.

Now, torque ripples are generated in the three-phase motor upon superposition of the fundamental and space harmonics of the order n=5, 7, 11, 13 in sine-approximation method with, for example, only time harmonic of the order m=1 contained in phase current because torque ripples are generated when the order m of space harmonic in magnetic flux waveform of one phase for one magnetic pole and the order n of time harmonic in phase current of the same phase are combined to meet the condition that n±m=6f (f is the natural number).

In the electric rotating machine 10 in the form of a 3-phase IPM motor in which twelve (12), in number, slots 18 face one of magnetic poles, magnetic reluctance is high at 12 places during one cycle in electrical degrees because permeance of air in opening of each of the slots 18 (a gap between edges of two adjacent stator teeth 15 to allow entry of a coil) to admit flow of magnetic flux is low. The magnetic reluctance at each of the slots 18 on such 12 places causes superimposition of the 11^{th} and 13^{th} order space harmonics (n=11, 13) on the magnetic flux waveform. These 11^{th} and 13^{th} order space harmonics (n=11, 13), so-called “slot harmonics”, may be easily reduced by staggering timing of magnetic reluctance in each of the slots 18 by rotating the permanent magnets 16 with respect to the rotor axis by a skew angle that is determined depending on an axial position of the magnets 16. To avoid giving a skew angle to the permanent magnets 16 within the rotor 12, the slot harmonics can be reduced in various different ways, for example, including putting a stake of electrical steel into the opening of each slot after inserting coils into the slots 18 or narrowing the width of the slot opening to reduce magnetic reluctance to reduce the slot harmonics or introducing anti-phase harmonics into motor control to reduce the slot harmonics. In this manner, the 11^{th} and 13^{th} order space harmonics can be easily reduced.

The 3-phase IPM structure allows a magnetic flux, waveform passing through one stator tooth to approximate a square waveform as shown in FIG. 3 and thus easy superimposition of the 5^{th} and 7^{th} space harmonics (the space harmonics each of which has the order n that if it is combined with the order in of a time harmonic makes 6f expressed as 6f=n±m, where f is the natural number and f=1 in this example), making it difficult to reduce such space harmonics.

Referring now to FIG. 4, having observed the illustrated torque waveform per one cycle in electrical degrees resulting from simulation, it is found that the above-mentioned 3-phase IPM motor creates a pulsating torque that repeats the maximum torque A and the minimum torque B six times. Having evaluated the magnetic flux density distribution at each of times of the maximum torque A and minimum torque B events, it is found that the magnetic flux per stator tooth 15 at one of times of the minimum torque B events differs in level or density from that at another time and superimposition of space harmonics proportional to such difference causes an increase in torque ripples.

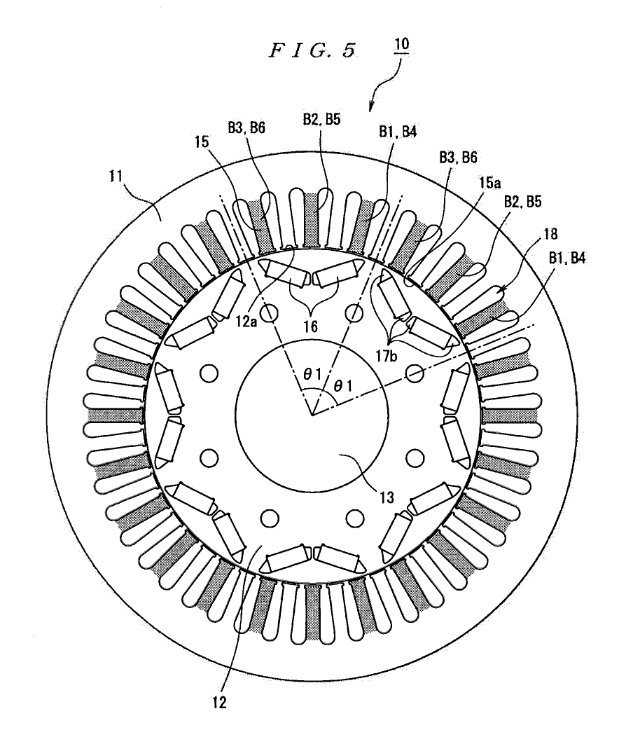

With regard to the magnetic flux density distribution at each of times E1 to B6 of the minimum torque B events, the magnetic flux density through one stator tooth 15 is larger or higher than that through an adjacent tooth during half of one cycle so that the same every other tooth is subject to such increased magnetic flux density per every half of one cycle as readily seen from FIG. 5 that illustrates only one cycle in electrical degrees. It follows that superimposition of space harmonics proportional to the difference in magnetic flux density between every other tooth and an adjacent tooth results in an increase in torque ripples. Here, one cycle in electrical degrees (360°) corresponds to twice a magnet opening angle θ1 for one magnetic pole opening angle of permanent magnets 16 of each pair including flux barriers rib. In the electric rotating machine 10 in the form of an 8-pole 48-slot motor, one cycle of the rotor 12, i.e., one revolution through 360 in mechanical degrees, corresponds to four cycles in electrical degrees because a set of six slots face one magnetic pole and two of eight (8) magnetic poles make one cycle.

It follows from the preceding description that in order to correspond to that every other tooth which is subject to the increased magnetic flux density at the times of the minimum torque B, the length of every other tooth is shortened to adjust a distance x between its inner periphery surface 15a and the outer periphery surface 12a of the rotor 12. For example, the magnetic flux density passing through such every other tooth is reduced by an increased reluctance caused by an increment d in distance through the air gap G by which the distance xS (D2) through the air gap G between the rotor outer periphery surface 12a and a shortened tooth (called second tooth) 15S is made longer than the distance xL (D1) through the air gap G between the rotor outer periphery surface 12a and a relatively long tooth (called first tooth) 15L. In other words, the stator teeth 15 include two kinds in length of teeth such that every other tooth is shorter than an adjacent tooth.

With regard to determination of the length of each of the short stator teeth 15S, a ratio of a difference between the length of each of the short stator teeth 15S and the length of each of the long stator teeth 151, to the length of each of the long stator teeth 15L, called a tooth length shrinkage ratio, (or a ratio of a difference between an air gap distance xS from each of the short stator teeth 15S to the outer periphery surface 12a of the rotor 12 and an air gap distance xL from each of the long stator teeth 15L to the air gap distance xL, called an air gap widening ratio 6) is determined by an electromagnetic field analysis using a finite element method in which the optimum conditions are found using the air gap widening ratio δ (d/xL) as a parameter, where d is the difference between the air gap distance xS and the air gap distance xL (d=xS−xL).

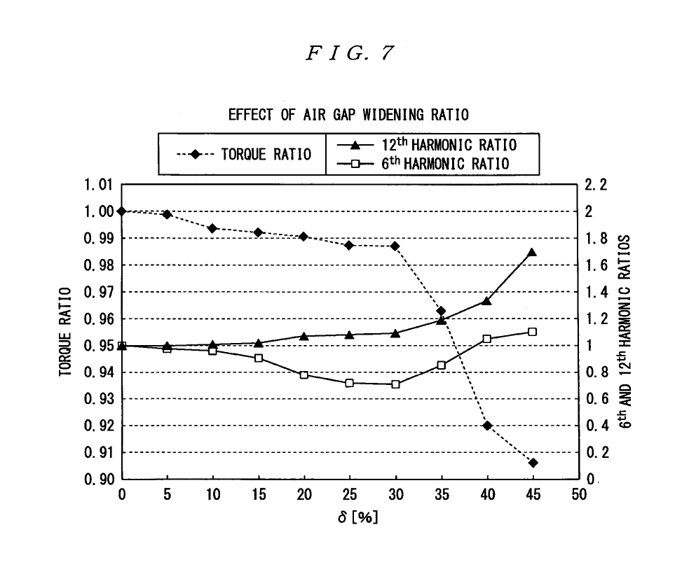

With the electromagnetic field analysis using the finite element method, an electric IPM motor including a stator with ununiform in length teeth has been evaluated against a conventional electric IPM motor including a stator with uniform in length teeth to give results, as shown in graphical representation of FIG. 7, after deriving a ratio between torque created by the ununiform in length teeth and that created by the uniform in length teeth, called a torque ratio, a ratio between the 6^{th} order harmonic torque component created by the ununiform in length teeth and that created by the uniform in length teeth, called the 6^{th} order harmonic ratio, and a ratio between the 12^{th} order harmonic torque component created by the ununiform in length teeth and that created by the uniform in length teeth, called the 12^{th} order harmonic ratio. As readily seen from the graphical representation of FIG. 7, all of the derived data are plotted against the air gap widening ratio δ based on given data when the air gap widening ratio δ is zero (δ=0). No effect is found on a reduction in the 6^{th} and 12^{th} order harmonic when the ratio δ is lower than 10%, the effect on a reduction in the 6^{th} order harmonic disappears when the ratio δ is equal to or higher than 40%, and the created torque itself drops in addition to an increase in the 12^{th} order harmonic when the ratio δ exceeds 30%.

There is a reduction in the 6^{th} harmonic without any considerable drop in the created torque when the air gap widening ratio δ falls in a range as indicated by the following condition 1, the 6^{th} harmonic can be reduced more when the air gap widening ratio δ falls in a range as indicated by the following condition 2, and the 6^{th} harmonic can be reduced further more when the air gap widening ratio δ falls in a range as indicated by the following conditions:

10%≦δ(d/D)≦30% Condition 1

20%≦δ(d/D)≦30% Condition 2

25%≦δ(d/D)≦30%. Condition 3

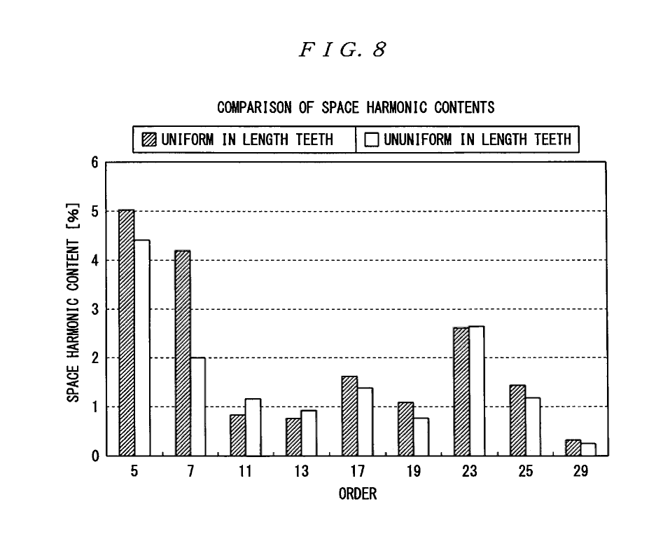

As FIG. 8 clearly shows, the 6^{th} harmonic component of torque, which is more difficult to be reduced than the 12^{th} harmonic component of torque because the 5^{th} space harmonic content and 7^{th} space harmonic content, each of which causes the 6^{th} harmonic component of torque in superimposition on induced voltage, can be reduced when the length of each of short stator teeth 15S of the stator 11 in the electric rotating machine 10 is adjusted so that the air gap widening ratio 6 falls in, for example, the range as indicated by the above-mentioned condition 3.

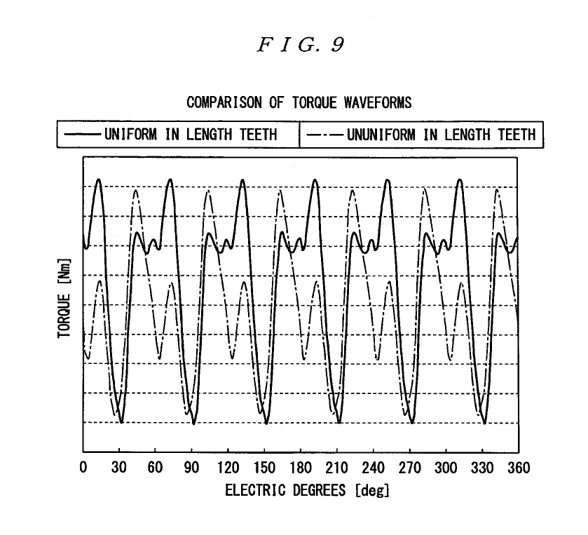

As FIG. 9 clearly shows, the electric rotating machine 10 provides a stabilized torque output adjusted to change gradually because the torque ripple, which occurs in the case the uniform in length stator teeth 15 are used and makes the car driver to feel uncomfortable, is reduced without any bad influence on the maximum and minimum of torque.

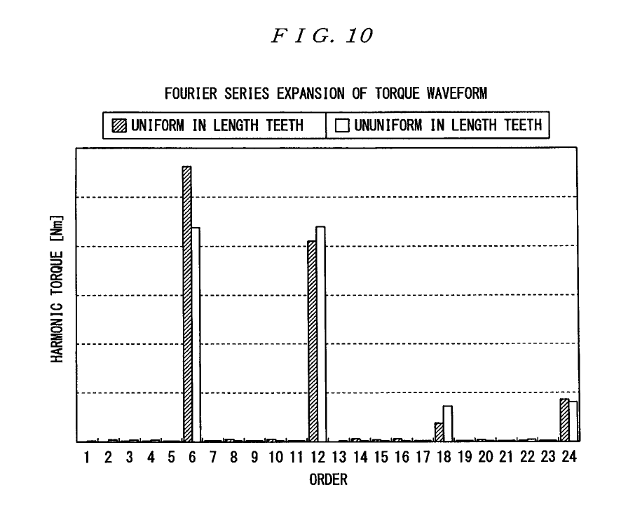

As Fourier series expansions of torque waveform shown in FIG. 10 clearly show, no difference is observed in reducing the 12^{th} harmonic component of torque, but the 6^{th} harmonic component of torque, which is more difficult to be reduced than the 12^{th} harmonic component of torque, can be reduced more significantly when the stator teeth 15 in the electric rotating machine 10 are not uniform in length than when they are uniform in length.

Reduction of, in particular, the 6^{th} harmonic component of torque in superimposition of the fundamental torque waveform is difficult in the case the stator teeth 15 of the stator 11 in the electric rotating machine 10 are uniform in length.

However, an effective reduction in torque ripple is accomplished only by forming every other stator tooth as a short tooth 15S that meets the condition 10%≦δ(d/D)≦30% or preferably 20%≦δ(d/D)≦30% or more preferably 25%≦δ(d/D)≦30%.

According to the present implementation, every other tooth of the stator teeth 15 of the stator 11 is a short tooth 15S that defines an air gap distance xS longer than an air gap distance xL defined by an adjacent long tooth 15L by an amount within a range restrained by the widening ratio δ (d/xL)=10% to 30%. This causes a reduction in torque ripple by reducing the 6^{th} harmonic component torque in superimposition on the fundamental torque waveform. Accordingly, this provides an electric rotating machine capable of providing a high quality and efficient machine operation with reduced oscillation and noise by lowering torque ripple.

In the preceding description of the present implementation, there is explained as one example the structure in which a plurality of pairs of permanent magnets 16 are embedded in a rotor 12 in a way that the magnets of each pair are located in a “V” shape configuration. This present implementation is not limited to this example, but it may be applied to, for example, the arrangement in which permanent magnets are embedded in a rotor 12 in a manner to face the periphery surface 12a to provide the same effects.

During the preceding description of the present implementation, taking an electric rotating machine 10 in the form of an 8-pole 48-slot motor as an example, it is described that one cycle of each pair of magnetic poles is equivalent to 360 electrical degrees, but this does not restrain the present invention. The present invention may find its application in motors including six (6) slots to each magnetic pole, such as, a 6-pole 36-slot, 4-pole 24-slot, 10-pole 60-slot motor, by employing only θ1 in electrical degrees in the range of the effective magnetic pole opening angle θ1.

It is not intended to limit the scope of the present invention to the embodiment illustrated and described. It should be appreciated that all of variants accomplishing equivalent effect(s) which are aimed at by the present invention exist within the scope of the present invention. It should be understood that various changes can be made in the function and arrangement of elements without departing from the scope of the present invention as set forth in the appended claims and the legal equivalents thereof.

### INDUSTRIAL APPLICABILITY

It should be appreciated that, although one embodiment of the present invention has been described, it is just an example and not intended to limit the scope of the present invention. It should also be appreciated that a vast number of variants exist without departing from the spirit of the present invention.

### EXPLANATION OF NOTATIONS

10 electric rotating machine
11 stator
12 rotor
12a outer periphery surface
13 rotor shaft
15 stator teeth
15a inner periphery surface
15L long stator tooth
15S short stator tooth
16 permanent magnet
16a corner portion
17 bores which are located in a “V” shape
17b flux barrier
18 slot
G center bridge
G air gap
xL, xS air gap distances

1. An electric rotating machine comprising a rotor with a rotor shaft located on a rotor axis and a stator rotatably receiving the rotor,
wherein said stator includes a plurality of teeth, which extend towards an outer periphery surface of said rotor and terminate at inner peripheral surfaces facing the peripheral surface of said rotor, and a plurality of slots, each between the adjacent two of the teeth, providing spaces for winding coils around said teeth for input of driving electric power,
wherein said rotor has a plurality of permanent magnets embedded therein so as to let magnetic force act on that surface portions of the teeth which are opposed to the permanent magnets,
wherein said rotor within said stator is driven to revolve by reluctance torque derived from magnetic flux passing through said teeth, rear surface side of the teeth and said rotor when current passes through said coils and magnet torque in the form of attraction and repulsion derived from interference with said permanent magnets,
wherein, when a set of permanent magnets of said plurality of permanent magnets corresponds to a set of slots of said plurality of slots and forms a magnet pole, magnetic reluctance between an inner periphery surface per tooth of said plurality of teeth and the outer periphery surface of said rotor is modified in such a way as to adjust torque fluctuation per tooth of said plurality of teeth upon relative movement of said one magnetic pole to said set of slots.

2. The electric rotating machine according to claim 1, wherein said plurality of teeth includes two kinds in length of teeth such that every other tooth of said plurality of teeth is of the one of the two kinds and an adjacent tooth is of the other of the two kinds.

3. The electric rotating machine according to claim 2,
wherein said one magnetic pole in said rotor is formed by embedding said one set of permanent magnets so that permanent magnets of a pair are located in a “V” shape configuration opening towards the outer periphery surface of said rotor, slots of said one set of said stator are six in number, and
wherein said plurality of teeth include long first teeth and short second teeth, each of said first long teeth and each of said second short teeth meeting the following condition:
0.1≦d/D1≦0.3
where D1 is the air gap distance between an inner periphery surface of each of the first long teeth and the outer periphery surface of said rotor, D2 is the air gap distance between an inner periphery surface of each of the second short teeth and the outer periphery surface of said rotor, and d is the difference between the distances D2 and D1 (D2−D1).
